(19) United States
(12) Patent Application Publication
(10) Pub. No.: US 2013/0220646 A1
(43) Pub. Date: Aug. 29, 2013

(54) COMPOSITION FOR CONTROLLING GRILL FLARE-UPS

(71) Applicant: GRATE CHEF, INC., (US)

(72) Inventor: W. Keith Aldredge, Thomasville, GA (US)

(73) Assignee: GRATE CHEF, INC., Hoschton, GA (US)

(21) Appl. No.: 13/778,877

(22) Filed: Feb. 27, 2013

Related U.S. Application Data
(60) Provisional application No. 61/605,017, filed on Feb. 29, 2012.

(51) Int. Cl. A62D 1/00

(52) U.S. Cl. CPC A62D 1/0042
USPC 169/46; 252/2

(57) ABSTRACT

A composition for eliminating flare-ups caused by fats or oils catching fire as a result of grilling food over an open source of flame is disclosed. The composition is non-toxic and does not produce off-flavors when it contacts the food, so the food is edible after the flare-up is extinguished. Methods of making the composition and of extinguishing a flare-up are also disclosed.

This application claims the benefit of U.S. Provisional Application No. 61/605,017, filed Feb. 29, 2012, the contents of which are herein incorporated by reference.

### BACKGROUND

Many people cook food over open flame sources. Sources of open flame such as gas and charcoal grills are popular across the United States and in many other countries as well. In some cases gas and charcoal grills are employed outdoors, though stoves and ovens can include natural gas grill type features in some models. Fire pits, fireplace features, and the like are also used to cook food outdoors over open flame, wherein gas, charcoal, wood, etc. are used as the fire source. Grills employ a cooking grate or some other feature to hold the food over the open flame, and expose the food directly to the heat of the flame beneath it.

Fire flare-ups can occur when employing any open flame source in conjunction with food placed on a grate above the flame. Any food containing fat or oil, whether present naturally in the food or as a result of a marinade or sauce for example, can provide fuel for a flare-up. A flare-up occurs when oil or fat drips into the open flame source and catches fire and/or when oil or melted fat on the surface of the food catches fire. In both cases, the food can come into direct contact with flames, potentially burning and charring the food. Additionally, such flare-ups create a safety hazard.

While in some cases it is possible to move the food away from the open flame source and allow the flare-up to burn itself out, in other cases this is either not possible or not practicable. For example, there may be too much food on the grate to move either the food or the grate quickly away from the flame source. Additionally, in some instances it is not practical or safe to simply allow a flare-up to burn itself out. For example, it is generally unsafe to allow a flare-up on an indoor stove or oven grill to burn itself out and create a house fire hazard.

The use of water to douse such flames is unsafe, because water tends to cause burning fats and oils to splatter. Further, water does not remove the source of ignition from the source of flame; the flare-up can easily re-ignite once the fat or oil warms back up. Use of chemical fire extinguishers intended for cooking and grease fires, for example Type K extinguishers, produce inedible food upon contact and usually douse the flame altogether, including the source of open flame. Additionally, the use of a fire extinguisher is typically overkill for small flare-ups; fire extinguishers are not intended for small doses of extinguishing chemicals to be applied to a flare-up, and in fact it is typically impossible to discharge small amounts of flame-dousing chemicals using an extinguisher apparatus.

There is a need for compositions for reducing or eliminating flare-ups caused by fats or oils catching fire as a result of grilling food over an open source of flame. Further, there is a need to provide such compositions that can be easily sprayed in small, controllable amounts on flare-ups such that the flare-up is doused but the open flame source is left burning. Further, there is a need to provide such compositions that do not result in reignition of a flare-up upon subsequent exposure of a doused flare-up to the open flame. Further, there is a need to provide such compositions that are non-toxic, so that the composition can be applied to the flare-up and contact the food without necessitating disposal of the food. Finally, there is a need to provide such compositions that do not impart an off-flavor to the food after contact of the composition with the food.

### SUMMARY

In a first embodiment, the invention is a composition for eliminating a flare-up caused by fats or oils catching fire as a result of grilling food over an open source of flame, the composition including about 15 wt % to 30 wt % potassium acetate, about 0.0001 wt % to 0.1 wt % of an anionic surfactant, and water. In embodiments, the anionic surfactant is a mixture of one or more anionic surfactants. In embodiments, the composition further includes one or more additional surfactants.

In a second embodiment, the invention is a method of extinguishing a flare-up caused by fats or oils catching fire as a result of grilling food over an open source of flame, the method including spraying the flare-up, the food, or both with a composition including about 15 wt % to 30 wt % potassium acetate, about 0.0001 wt % to 0.1 wt % of an anionic surfactant, and water. The surfactant is an anionic surfactant or a mixture of one or more anionic surfactants and one or more additional surfactants. In embodiments, the flare-up is caused by, or engulfs, a single food item weighing between 85 g to 142 g, and about 0.3 g to 1.2 g of the composition is sprayed onto the flare-up, the food, or both in order to extinguish the flare-up. In some embodiments, the spray is in the form of a stream; in other embodiments, the spray is in the form of a mist.

### DETAILED DESCRIPTION

Various embodiments will be described in detail herein. Reference to various embodiments does not limit the scope of the claims attached hereto. Additionally, any examples set forth in this specification are not intended to be limiting and merely set forth some of the many possible embodiments for the appended claims.

### COMPOSITIONS

The invention includes compositions for eliminating a flare-up caused by fats or oils catching fire as a result of grilling food over an open source of flame. A number of embodiments are within the scope of the invention.

In embodiments, the compositions are nontoxic to humans when used in suitable amounts. The compositions do not impart a noticeable off-flavor to grilled foods when used in suitable amounts. The compositions are easily sprayed in small, controllable amounts onto flare-ups such that a flare-up is quickly doused but the open flame source is left burning. The compositions do not result in reignition of a flare-up upon subsequent exposure of a doused flare-up to the open flame.

The compositions of the invention include water, an acetic acid salt, and at least one of an anionic surfactant, nonionic surfactant, a zwitterionic surfactant, or a combination thereof

In embodiments, the acetic acid salt is an alkali metal salt of acetic acid. Examples of useful alkali metals include lithium, sodium, and potassium. In these examples, the acetic acid salt is lithium acetate, sodium acetate, or potassium acetate. In some embodiments the alkali metal is potassium; that is, the acetic acid salt is potassium acetate. In some embodiments the acetic acid salt is a mixture of two or more alkali metal salts of acetic acid. In some embodiments, the acetic acid salt or mixture of salts includes a minor fraction of free acetic acid.

In embodiments, the acetic acid salt is an alkaline earth metal salt of acetic acid. Examples of useful alkaline earth metals include calcium or magnesium. In these examples, the acetic acid salt is calcium acetate or magnesium acetate. In some embodiments the acetic acid salt is a mixture of two or more alkaline earth metal salts of acetic acid. In some embodiments the acetic acid salt is a mixture of one or more alkaline earth metal salts of acetic acid and one or more alkali metal salts of acetic acid. In some embodiments, the acetic acid salt or mixture of salts includes a minor fraction of free acetic acid.

The acetic acid salt is included in the compositions of the invention at about 0.05 mol to 0.50 mol of the acetic acid salt per 100 g of the composition, or about 0.10 mol to 0.40 mol of the acetic acid salt per 100 g of the composition, or about 0.15 mol to 0.30 mol of the acetic acid salt per 100 g of the composition. Where the acetic acid salt is potassium acetate, the salt is present in the composition at about 5 g to 50 g of potassium acetate per 100 g of the composition; that is, the salt is present at about 5 wt % to 50 wt % based on the total weight of the composition. In some embodiments, potassium acetate is present in the composition at about 10 wt % to 40 wt %, or about 15 wt % to 30 wt %, or about 20 wt % to 30 wt %, or about 20 wt % to 25 wt %, or about 20 wt % to 23 wt %, or about 22 wt % to 25 wt % based on the total weight of the composition. Any specific concentration or range of concentrations between 5 g and 50 g of potassium acetate per 100 g of the composition is also employed and falls within the scope of the invention. For example, between 5 wt % and 25 wt %, or 5 wt % to 40 wt %, or 10 wt % to 30 wt %, or 15 wt % to 40 wt % of potassium acetate is present in the composition, or any other range between 5 wt % and 50 wt % potassium acetate is present based on the total weight of the composition.

In certain embodiments, the compositions of the invention include at least one surfactant. The composition optionally includes an anionic surfactant, a mixture of two or more anionic surfactants, a nonionic surfactant, a mixture of two or more nonionic surfactants, a zwitterionic surfactant, a mixture of two or more zwitterionic surfactants, or a mixture of two or more surfactants or surfactant mixtures thereof. A surfactant is a substance that lowers the surface tension of the medium in which it is dissolved, and/or the interfacial tension with other phases, and, accordingly, is positively adsorbed at the liquid/vapor and/or at other interfaces. (PAC, b 1972, 31, 577 (Manual of Symbols and Terminology for Physicochemical Quantities and Units, Appendix II: Definitions, Terminology and Symbols in Colloid and Surface Chemistry), page 611.) In some embodiments, one or more of the surfactants have detergent properties. A detergent is a surfactant (or a mixture of one or more surfactants) having cleaning properties in dilute solutions. (PAC, 1972, 31, 577 (Manual of Symbols and Terminology for Physicochemical Quantities and Units, Appendix II: Definitions, Terminology and Symbols in Colloid and Surface Chemistry), page 612.) In some embodiments, the surfactant employed in the composition is effective in lowering the surface tension of the solution, but has a low degree of sudsing in the composition. Minimizing of sudsing in the composition is accomplished by minimizing the amount of surfactant employed, by selecting a surfactant that results in low sudsing in water solutions of the acetic acid salt, or by using both approaches as will be appreciated by one of skill. In all cases, the surfactant employed in the compositions of the invention are food safe, and result in no food off-flavors when employed in the compositions of the invention.

In embodiments, the composition includes a combination of one or more surfactants, wherein at least one anionic surfactant is included in the composition. A blend of two or more anionic surfactants, or two or more nonionic surfactants, or two or more zwitterionic surfactants are suitably employed in the compositions of the invention wherein the composition includes at least one anionic surfactant. A blend of at least one anionic surfactant with at least one nonionic surfactant is suitably employed in the compositions of the invention. A blend of at least one anionic surfactant with at least one zwitterionic surfactant is suitably employed in the compositions of the invention.

Suitable anionic surfactants include sulfate, sulfonate, phosphate, or carboxylate compounds. Examples of suitable anionic surfactants include:

Sulfates
Alkyl sulfates such as ammonium lauryl sulfate and sodium lauryl sulfate (sodium dodecyl sulfate)
Alkyl ether sulfates such as sodium laureth sulfate (sodium lauryl ether sulfate) and sodium myreth sulfate

Sulfonates
Docusates such as dioctyl sodium sulfosuccinate
Alkyl benzene sulfonates (linear or branched)

Phosphates
Alkyl aryl ether phosphates
Alkyl ether phosphates

Carboxylates
Alkyl carboxylates salts such as sodium stearate or ammonium stearate
Sodium lauroyl sarcosinate
   In embodiments, sodium lauryl sulfate, alkyl benzene sulfonates, ethoxylated alkyl sulfonates, or a mixture thereof is employed in the compositions of the invention.

Examples of suitable nonionic surfactants include:

Fatty alcohols such as cetyl alcohol, stearyl alcohol, cetostearyl alcohol (mixtures of predominantly of cetyl and stearyl alcohols), and oleyl alcohol

Polyoxyethylene glycol alkyl ethers, CH₃—(CH₂)₉₋₁₅—(O—C₂H₄)₁₋₂₅—OH, such as octaethylene glycol monododecyl ether and pentaethylene glycol monododecyl ether

Polyoxypropylene glycol alkyl ethers, CH₃—(CH₂)₉₋₁₅—(O—C₃H₆)₁₋₂₅—O

Glucoside alkyl ethers such as decyl glucoside, lauryl glucoside, and octyl glucoside

Polyoxyethylene glycol alkylphenol ethers such as C₈H₁₇—(C₆H₄)—(O—C₂H₄)₁₋₂₅—OH and C₉H₁₉—(C₆H₄)—(O—C₂H₄)₁₋₂₅—OH

Glycerol alkyl esters such as glyceryl laurate

Polyoxyethylene glycol sorbitan alkyl esters

Sorbitan alkyl esters

Cocamide MEA, cocamide DEA

Alkyldimethylamine oxides, such as dodecyldimethylamine oxide

Block copolymers of polyethylene glycol and polypropylene glycol

Polyethoxylated tallow amine

In embodiments, alkyldimethylamine oxides having between 12 and 16 carbons in the alkyl group, polyoxyethylene glycol alkyl ethers having between 10 and 16 carbons in the alkyl group and 8 to 12 oxyethylene groups, or a mixture thereof is employed in the compositions of the invention.

Examples of suitable zwitterionic surfactants include:

Primary, secondary, or tertiary amines or quaternary ammonium cations of sulfonates, such as 3-[(3-Cholamidopropyl)dimethylammonio]-1-propanesulfonate (“CHAPS”)

Sultaines, such as cocamidopropyl hydroxysultaine;

Carboxylate functional amino compounds, including amino acids, imino acids, and betaines such as cocamidopropyl betaine

Phosphates such as lecithin

In some embodiments, a mixture of one or more of the foregoing is included in the composition of the invention.

The total amount of surfactant or blend of surfactants present in the compositions of the invention is typically equal to or less than 0.5 wt % based on the total amount of the composition. Thus, in some embodiments, the total amount of surfactant is about 0.00001 wt % to 0.5 wt %; or about 0.00001 wt % to 0.4 wt %; or about 0.0001 wt % to 0.3 wt %; or about 0.0001 wt % to 0.2 wt %; or about 0.0001 wt % to 0.1 wt %; or about 0.0001 wt % to 0.01 wt %; or about 0.0001 wt % to 0.005 wt % based on the total amount of the composition. Any specific concentration or range of concentrations between 0.00001 wt % and 0.5 wt % based on the total amount of the composition is also suitably employed and falls within the scope of the invention. It will appreciated that the amount of surfactant employed in the various embodiments of the invention will depend strongly on the type of surfactant and specific species thereof selected, or blend of surfactants employed. Hydrophilic-lipophilic balance, detergent power, and molecular weight, for example, will vary greatly between surfactants and the concentration employed for each surfactant or blend thereof will reflect optimization by one of skill. While in some embodiments of the invention an anionic surfactant is not required, in many emb

Additional ingredients are included in some compositions of the invention. In some embodiments, cosolvents are be included in the compositions; examples of suitable cosolvents include glycerol, oxyalkylene oligomers such as diethylene glycol or triethylene glycol, alkylene diamines, alkanolamines and dialkanolamines, and the like. In some embodiments, stabilizers are included in the composition; examples of suitable stabilizers include sodium bisulfite and pentasodium pentatate. In some embodiments, rheology control additives are included in the composition; examples of rheology control additives include sodium chloride, magnesium sulfate, polymers such as polypropylene glycol, polyethylene glycol, polyvinyl alcohol, and polyvinyl acetate homopolymers and copolymers, and in some embodiments one or more of the cosolvents listed above. In some embodiments, one or more fragrances, dyes, natural fruit oils, preservatives, thermooxidative stabilizers, or other adjuvants are included in the composition. Blends of one or more of each type of the additional ingredients, as well as blends of one or more types of additional ingredients, are employed in various embodiments of the compositions of the invention.

Additional ingredients are present in the compositions of the invention at less than or equal to 0.5 wt %, in a combined total amount, based on the total amount of the composition. In some embodiments, the total amount of an additional ingredient is about 0.0001 wt % to 0.5 wt %; or about 0.0001 wt % to 0.4 wt %; or about 0.0001 wt % to 0.3 wt %; or about 0.001 wt % to 0.2 wt %; or about 0.001 wt % to 0.1 wt %; or about 0.001 wt % to 0.01 wt %; or about 0.001 wt % to 0.005 wt % of combined additional ingredients based on the total amount of the composition.

In every embodiment, the balance of the composition in addition to the one or more acetic acid salts, the one or more surfactants, and the one or more additional ingredients will vary depending on the type and amount of the acetic acid salts, surfactants, and additional ingredients. Where the acetic acid salt is potassium acetate, the amount of water varies between about 49 wt % to 96 wt % based on the total amount of the composition, or about 60 wt % to 90 wt % based on the total amount of the composition, or about 70 wt % to 80 wt % based on the total amount of the composition.

Methods.

In an embodiment, the invention is a method of eliminating a flare-up caused by fats or oils catching fire as a result of grilling food over an open source of flame, the method including forming a solution or dispersion of the composition as described above, filling a container with the composition, and employing small aliquots of the composition in spray form to douse a flare-up that results from cooking fat-containing food over an open source of flame. In embodiments a user sprays the composition of the invention onto food situated over or within the flare-up such that the composition extinguishes the flare up, and prevents subsequent flare-ups. In embodiments, the user contacts the food directly with the composition of the invention by spraying the composition onto and around the flare-up. The user is able to ingest the food subsequent to contacting the composition with no toxicity or harmful effects from ingesting the residue of the composition and no off-flavor effects.

The composition is formed by adding water to a vessel, agitating the water, adding a concentrated solution of the acetic acid salt stepwise or continuously over time, agitating the solution thus formed, and adding a solution or dispersion of one or more surfactants and additional ingredients to the vessel with agitation. In embodiments, the acetic acid salt is potassium acetate and the concentrated solution thereof is a 50 wt % solution. In some such embodiments, the concentrated solution of potassium acetate is added to the water in the vessel over a period of between about 1 minute and 100 minutes. In embodiments, the surfactant or surfactant mixture along with all the additional ingredients is added to the acetic acid salt in a single aliquot. In some such embodiments, the mixture of surfactants plus additional ingredients is dispersed in a water or water/ethanol solution. In some such embodiments, the mixture of surfactants plus additional ingredients dispersed in water or water/ethanol solution is JOY® Hand Dishwashing Liquid (Lemon), sold by the Procter and Gamble Co. of Cincinnati, Ohio.

In embodiments, the container employed by an end user of the composition is a spray bottle, for example a hand pump bottle such as is commonly found in department, drug, or grocery stores for spraying a mist or finely divided stream of water or some other liquid or solution. The volume of the composition that is employed to extinguish a flare-up will be dependent on the size of the flare-up, the number and size of the food products involved, the fat or oil content of the food items, the residual fat or other materials present at or near the source of the open flame being used to cook the food, and the like. However, a single pump from an average pump spray bottle is often sufficient to extinguish a flare up of a fat containing food item such as a hamburger, steak, skin-on chicken breast, and the like; or an oil containing food item such as a marinated skinless chicken breast, sauce-coated fish fillet, or oil coated vegetable or fruit kabob. Where multiple food items are being cooked or a flare up is extensive, for example, 2 to 10 pumps from a hand pump spray bottle, for example about 4 to 6 pumps, may be required to extinguish a flare-up.

The amount of the composition delivered to the flare-up by a spray bottle will vary depending on the bottle nozzle and pump apparatus employed to spray the composition. In embodiments, a single pump from a spray bottle delivers between about 0.2 g and 1.2 g of the composition, or between about 0.3 g and 1.0 g of the composition. The spray is, in various embodiments, a stream of the composition or a mist of droplets, as will be readily understood by those who have used such spray mechanisms; in some embodiments, the spray is adjustable between a stream and a mist of droplets. The amount of spray bottle pumps required to extinguish a flare-up will depend on the nature of the spray (stream, mist, or in between), amount of composition delivered per pump, and how accurately the user employs the spray in directing it toward the flare-up. In some embodiments, a single pump from a standard spray bottle is sufficient to extinguish a flare-up. For example, in embodiments, where a single piece of heavily marbled steak weighing about 3 oz to 5 oz (85 g to 142 g) cooked on the “high” setting on a gas grill causes a flare-up, a single pump from a spray bottle is sufficient to extinguish the flare-up. Using the same pump bottle of water, in embodiments 5-10 pumps are required to extinguish such a flare-up.

Once extinguished, the fat or oil that caused the flare-up does not cause a subsequent re-ignition once the fat or oil is reheated by the open flame source. That is, the composition of the invention effectively removes the fat or oil as a fuel source for burning. Subsequent flare-ups can occur, but they occur as a result of additional fat or oil from the food source emanating from the food and igniting. Additional aliquots of the composition are dispensed on the food items and into any subsequent flare-ups with no harmful effects—that is, there is no toxic or harmful effects of ingesting the residue of the compositions and there is no off-flavor taste associated with one or even repeated uses of the composition on a single food item.

The user who employs the compositions of the invention to extinguish one or more flare-ups can subsequently ingest such food items with no harmful effects and no off-flavors.

### Experimental Section

### Example 1

A clean stainless steel kettle capable of carrying between 100 and 150 gallons of a liquid was charged with 44 gallons (368 lb, 166.9 kg) of tap water. A lightning edge type agitator was employed at an agitation rate sufficient to create a small vortex in the kettle. Once the vortex was established, 27 gallons (290 lb, 131.5 kg) of a 50 wt % solution of potassium acetate (50 g potassium acetate per 100 g solution) was added to the water at a rate of about 10 gallons per minute. After the addition was complete, the mixture was stirred for an additional period of approximately 10 minutes. Then the rate of stirring was decreased sufficiently to avoid sudsing during the subsequent addition of surfactant to the mixture, and 1 quart (2 lb, 0.9 kg) of JOY® Hand Dishwashing Liquid (Lemon), manufactured by the Procter and Gamble Co. of Cincinnati, Ohio, was added in a single aliquot to the kettle. Mixing was continued for about 10 minutes, at a rate sufficient to avoid sudsing of the mixture. Then the mixture was distributed into pump spray bottles for use.

### Example 2

A clean stainless steel kettle capable of carrying between 100 and 150 gallons of a liquid was charged with 77 gallons (643 lb, 291.7 kg) of tap water. A lightning edge type agitator was employed at an agitation rate sufficient to create a small vortex in the kettle. Once the vortex was established, 47 gallons (504 lb, 228.6 kg) of a 50 wt % solution of potassium acetate (50 g potassium acetate per 100 g solution) was added to the water at a rate of about 10 gallons per minute. After the addition was complete, the mixture was stirred for an additional period of approximately 10 minutes. Then the rate of stirring was decreased sufficiently to avoid sudsing during the subsequent addition of surfactant to the mixture, and 2 quarts (3.5 lb, 1.6 kg) of JOY® Hand Dishwashing Liquid (Lemon), manufactured by the Procter and Gamble Co. of Cincinnati, Ohio, was added in a single aliquot to the kettle. Mixing was continued for about 10 minutes, at a rate sufficient to avoid sudsing of the mixture. The specific gravity of the resulting mixture was 1.10-1.11 g/mL. Then the mixture was distributed into 22 oz (0.65 liter) pump spray bottles for use. About 750 g of the composition was added to each spray bottle.

The present invention may suitably comprise, consist of, or consist essentially of, any of the disclosed or recited elements. The invention illustratively disclosed herein can be suitably practiced in the absence of any element which is not specifically disclosed herein. The various embodiments described above are provided by way of illustration only and should not be construed to limit the claims attached hereto. It will be recognized that various modifications and changes may be made without following the example embodiments and applications illustrated and described herein, and without departing from the true spirit and scope of the following claims.

We claim:

1. A composition comprising
about 15 wt % to 30 wt % potassium acetate,
about 0.00001 wt % to 0.1 wt % of an anionic surfactant, and water.

2. The composition of claim 1 wherein the anionic surfactant is sodium lauryl sulfate.

3. The composition of claim 1 wherein the anionic surfactant is a mixture of two or more anionic surfactants.

4. The composition of claim 1 wherein the composition further comprises one or more nonionic surfactants.

5. The composition of claim 4 wherein the one or more nonionic surfactants is an alkyldimethylamine oxide.

6. The composition of claim 5 wherein the alkyldimethylamine oxide is a mixture of alkyldimethylamine oxides wherein the alkyl groups are C₁₂, C₁₄, and C₁₆ alkyl groups.

7. The composition of claim 1 wherein the composition comprises about 20 wt % to 25 wt % potassium acetate.

8. The composition of claim 1 wherein the composition comprises about 22 wt % to 23 wt % potassium acetate.

9. A method of extinguishing a flare-up caused by fats or oils catching fire as a result of grilling food over an open source of flame, the method comprising spraying the flare-up, the food, or both with the composition of claim 1.

10. The method of claim 9 wherein the flare-up is caused by, or engulfs, a single food item weighing between 85 g to 142 g, and about 0.3 g to 1.2 g of the composition is sprayed onto the flare-up, the food, or both.

11. The method of claim 9 wherein the spray is in the form of a stream.

12. The method of claim 9 wherein the spray is in the form of a mist.

13. The method of claim 9 wherein the composition contacts the food.
